(19) United States
(12) Patent Application Publication
(10) Pub. No.: US 2009/0185707 A1
(43) Pub. Date: Jul. 23, 2009

(54) AUDIO HEADSET ASSEMBLY WITH BUILT-IN JACK

(76) Inventor: Ashton Smith, Palos Verdes Estates, CA (US)

Correspondence Address: JOSEPH SWAN, A PROFESSIONAL CORPORATION, 1334 PARKVIEW AVENUE, SUITE100, MANHATTAN BEACH, CA, 90266, US

(21) Appl. No.: 12/111,175

(22) Filed: Apr. 28, 2008

Related U.S. Application Data
(60) Provisional application No. 61/023,057, filed on Jan. 23, 2008.

(51) Int. Cl. H04R 5/033

(52) U.S. Cl. 381/384

(57) ABSTRACT

Provided are, among other things, a variety of different audio headset assemblies. According to one embodiment, an audio headset assembly includes: a plug configured to mate with an audio device jack; an audio headset; a cord that electrically couples the plug to the audio headset; and a jack that (1) is integrated with at least one of the audio headset, the cord or the plug, (2) is configured to mate with a second plug, and (3) has electrodes electrically coupled to corresponding electrodes of the plug.

This application claims the benefit of U.S. Provisional Patent Application Ser. No. 61/023,057, filed on Jan. 23, 2008, and also titled “Audio Headset Assembly with Built-In Jack”, which application is incorporated by reference herein as though set forth herein in full.

### FIELD OF THE INVENTION

The present invention pertains to audio headset assemblies, such as assemblies that include any or all of: a computer headset, a telephone headset, a monaural headphone and/or stereo headphones.

### BACKGROUND

Conventionally, if a user of a personal electronic device such as a CD player, DVD player, laptop computer, iPod™ or other MP3 player, cordless telephone, wireless telephone (e.g., cellular-based), voice recorder or other device that provides audio output and/or accepts audio input wished to share the audio portion of a program through the use of headsets, or wished to speak together into a single audio device, the user would have had to purchase (or otherwise obtain) an appropriate audio splitter. Then both users would plug their headsets into the jacks of the audio splitter. If three or more users wished to listen or participate, it typically would have been necessary to purchase (or otherwise acquire) three splitters and plug them together in tree fashion. If the user did not have the required splitter(s) on hand, there often would not have been a way to share the audio with other users, except possibly by using a provided loudspeaker, and that solution often either is not available or is not appropriate for particular circumstances.

### SUMMARY OF THE INVENTION

The present invention addresses this problem by providing headset assemblies that have integrated jacks, e.g., for allowing another user to plug in and share the audio signal.

Thus, one embodiment of the invention is directed to an audio headset assembly that includes: a plug configured to mate with an audio device jack; an audio headset; a cord that electrically couples the plug to the audio headset; and a jack that (1) is integrated with at least one of the audio headset, the cord or the plug, (2) is configured to mate with a second plug, and (3) has electrodes electrically coupled to corresponding electrodes of the plug.

Another embodiment is directed to an audio headset assembly that includes: a plug configured to mate with an audio device jack and, upon such mating, to receive an electrical audio signal from the audio device; a headset, including a transducer that converts the electrical signal into output audio; a cord extending from the plug to the headset, for conveying the electrical signal from the plug to the headset; and a headset assembly jack, integrated with at least one of the headset, the cord or the plug, and configured to accept a second plug and thereby supply at least a portion of the electrical signal to the second plug.

As a result of integrating a jack into a headset assembly in either of the foregoing ways, it often is possible to avoid having to use a splitter in order to share an audio signal. In addition, by minimizing the number of temporary (e.g., plug-in) electrical connections, it often is possible to improve the resulting signal quality.

The foregoing summary is intended merely to provide a brief description of certain aspects of the invention. A more complete understanding of the invention can be obtained by referring to the claims and the following detailed description of the preferred embodiments in connection with the accompanying figures.

### BRIEF DESCRIPTION OF THE DRAWINGS

In the following disclosure, the invention is described with reference to the attached drawings. However, it should be understood that the drawings merely depict certain representative and/or exemplary embodiments and features of the present invention and are not intended to limit the scope of the invention in any manner. The following is a brief description of each of the attached drawings.

FIG. 1 is a cross-sectional view of a plug/jack assembly with a plug inserted into the jack portion.

FIG. 2 is a cross-sectional view of the portion of a headset assembly cord at which a jack is integrated, with a plug inserted into the jack.

FIG. 3 is a perspective view of a headset assembly that includes an integrated plug/jack assembly.

FIG. 4 is a perspective view of a headset assembly having a jack integrated into its cord at the point at which the cord divides into left and right audio channel branches.

FIG. 5 is a perspective view of a headset assembly having a jack integrated into the headset portion.

### DESCRIPTION OF THE PREFERRED EMBODIMENT(S)

The present invention typically can eliminate the need for audio splitters in situations in which one wishes to share audio with another. More specifically, the present invention provides, among other things, a headset assembly that includes a plug that can be inserted into a compatible audio device (or into the jack of another headset assembly according to the present invention) and also includes a jack for accepting the plug of another headset assembly. The referenced jack can be located, e.g., at the plug of the first headset assembly, at its left/right (L/R) channel separator, at any other location along the headset assembly's cord or within some portion of the headset itself. In any event, this general configuration allows a second user to insert his or her headset plug (whether or not in accordance with the present invention) into the jack of the inventive headset assembly which, in turn, plugs (either directly or indirectly) into an audio device that one wishes to share.

As used herein, the term “audio device” means any device that is capable of inputting and/or outputting an audio signal, and can include, e.g., audiovisual devices. The term “headset” as used herein means any audio transducer device that attaches to or is worn over some portion of the user's head, and can include, e.g., a single earphone (i.e., in-ear, with or without a wire loop or other mechanisms for securing the earphone to the user's ear), a pair of earphones (for stereo), one or more on-the-ear or over-the-ear headphones, a boom microphone and/or any other types of microphones, headphones or earphones; in addition, a headset according to the present invention can be passive (i.e., non-powered) or active (e.g., battery-powered, such as a headset with noise-canceling circuitry or circuitry for buffering, amplifying or combining microphone signals from one or more headset assemblies).

As a result of using a headset assembly according to the present invention, the user typically no longer needs to acquire and continuously have available one or more audio splitters in order to have the ability to share audio programming or audio capabilities of a single audio device. Furthermore, each additional headset assembly in accordance with the preferred embodiments of the present invention allows another headset user (or other headset users) to join in, by simply daisy-chaining as many headset assemblies as desired.

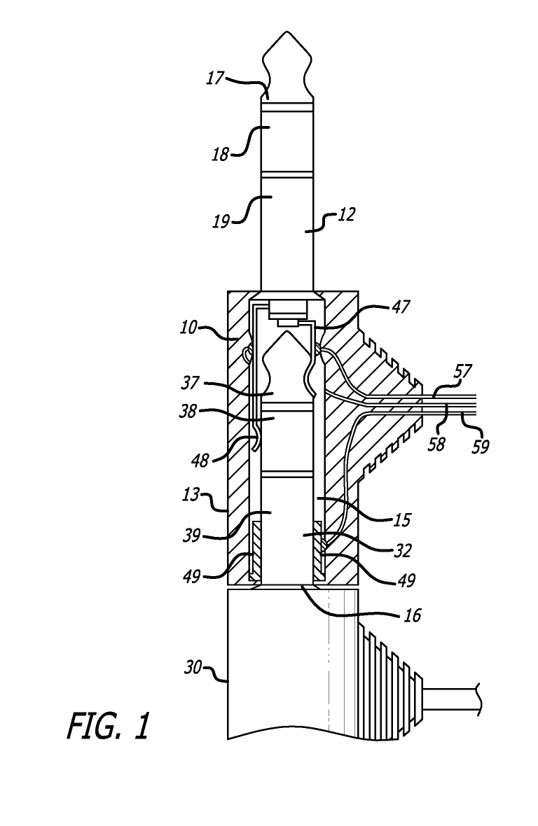

An example of a portion of a headset assembly according to the present invention is shown in FIG. 1. In the present example, the headset assembly includes an integrated plug/jack assembly and, for the most part, only such integrated plug/jack assembly for the headset assembly is illustrated in FIG. 1. More specifically, sectional views of an entire plug/jack assembly 10 for a first headset assembly and of a portion of a plug/jack assembly 30 for a second headset assembly are illustrated in FIG. 1. As shown, plug/jack assembly 10 includes a plug 12 and a body (or housing) portion 13, with the body portion 13 including a cavity 15 that functions as a jack for accepting another plug through opening 16. In the present case, plug 32 of plug assembly 30 is inserted into jack 15. As used herein, the term “plug” refers to a male electrical connector and the term “jack” refers to a female electrical connector.

In the present embodiment, plug 12 has three connection electrodes 17-19 and, similarly, the plug 32 has three connection electrodes 37-39. Each of electrodes 17-19 is electrically connected (e.g., soldered, formed as a unitary piece or otherwise permanently and/or securely connected) to a corresponding jack electrode 47-49, respectively, which, in turn, contacts corresponding plug connection electrodes 37-39, respectively, when plug 32 is inserted into jack 15. In the preferred embodiments, a corresponding wire 57-59 is soldered (or otherwise permanently and/or securely connected) to each such common connection and leads to the headset portion (not shown) of the headset assembly, exiting from the side of plug/jack assembly 10.

The jack portion 15 of plug/jack assembly 10 preferably is constructed using a steel (or other preferably conductive metal) tubular housing in order to provide structural integrity, e.g., in the manner of a conventional jack. Also similar to conventional jacks, the jack portion 15 of plug/jack assembly 10 can include insulating sleeves or other insulators to prevent the various connection electrodes 47-49 and associated electrical conductors from accidentally coming into contact each other. As a result of this construction, plug 12 and jack 15 are integrated with each other into a single assembly 10.

In the preferred embodiments, jack 15 is configured to accept a plug that is identical to plug 12, so that any number of headset assemblies that have the same plug assembly can be daisy-chained. However, it also is possible to provide a jack that accepts a different kind and/or size of plug than plug 12.

It is noted that in the present embodiment, jack 15 is coaxially aligned with plug 12. This structure is believed to provide the best physical integrity, to best facilitate daisy-chaining of multiple plugs and to provide the smallest package for plug/jack assembly 10. However, other configurations also are possible. For example, in one alternate embodiment jack 15 is oriented at a right angle relative to plug 12.

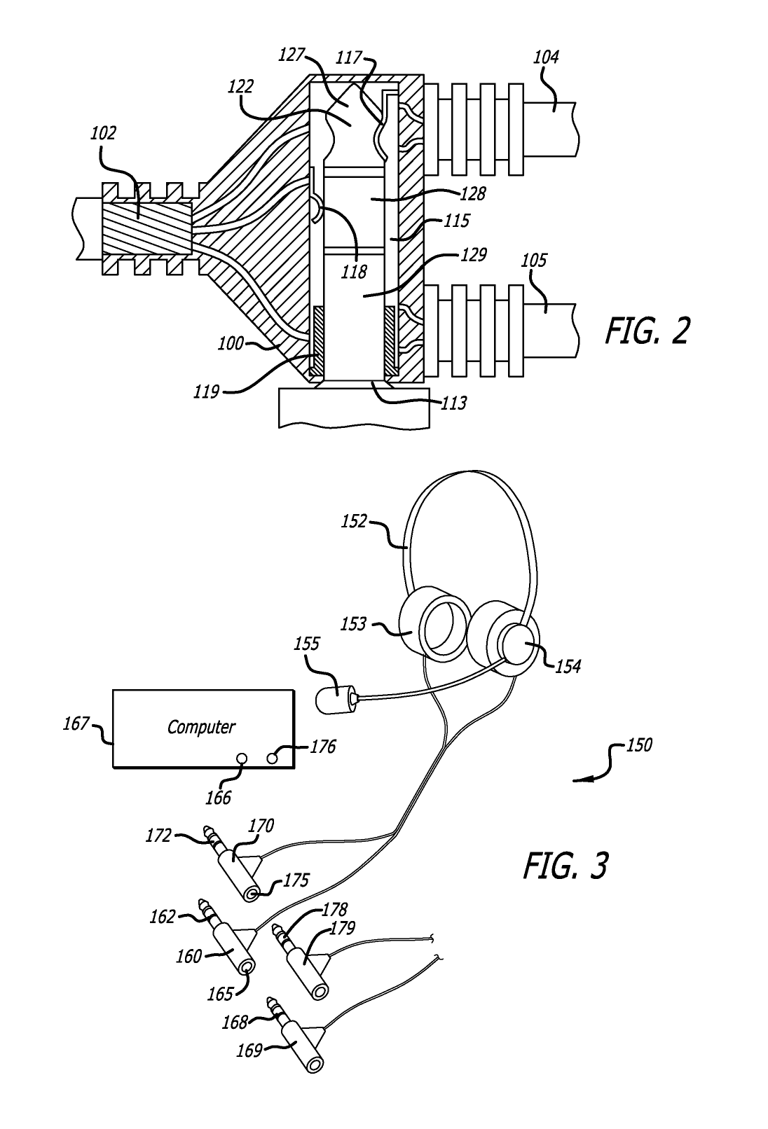

A portion of a headset assembly according to another embodiment of the invention is illustrated in FIG. 2. Here, a jack assembly 100 is integrated with the left/right (L/R) channel separator, i.e., the point at which the bundle of three wires 102 arriving from the headset assembly plug (not shown) is divided into two pairs of wires 104 and 105 going to the left and right headset transducers (not shown), respectively. In the example shown in FIG. 2, a plug 122 from a different headset assembly is inserted into the jack 115 of jack assembly 100 (through opening 113).

More preferably, the wires 102 are soldered (or otherwise permanently and/or securely connected) to the three jack connection electrodes 117-119 that correspond to the respective connection electrodes the jack for the subject headset assembly (not shown). As a result, when plug 122 is inserted into jack assembly 100 each of the connection electrodes 127-129 for plug 122 are electrically connected to the corresponding connection electrodes for the jack of the subject headset assembly. The wires within branches 104 and 105 preferably are permanently and/or securely attached either to the corresponding wires in the main trunk 102 and/or to the respective jack connection electrodes 117-119. In other words, in the present embodiment jack assembly 100 preferably is fully integrated within the headset assembly cord, rather than being temporarily connected to it or capable of being easily disconnected from it.

One advantage of the configuration illustrated in FIG. 2 is that the individual users who are sharing the audio device can be located progressively further away from it, as opposed to the first embodiment described above in which all of the users generally are required to be congregated around the audio device at a maximum distance equal to the length of the headset cord.

In addition to the stand-alone embodiments described above, aspects of the foregoing embodiments can be combined into a single embodiment. For example, in one embodiment one jack is included in the plug assembly, and another jack is included in the L/R channel separator for a single headset assembly.

More generally, a headset assembly according to the present invention can include one or more jacks located at any position(s) from and including the plug assembly to and including the headset itself, provided that the necessary wires/signals are available at that position. For example, if it is desired to include a stereo jack, then that jack preferably is included at some position at or prior to where the wires are divided into two separate stereo channel branches. On the other hand, many headsets are monaural (e.g., with or without a microphone boom), in which case a jack can be integrated into the audio plug, the cord between the audio plug and the headset and/or the headset itself. A jack can also be included after the wires corresponding to the left and right channels have been separated, e.g., if only a single channel is desired to be monitored (i.e., only a portion of the audio signal).

For ease of construction, it generally is preferred to incorporate the headset jack(s) into the headset assembly's plug assembly or along the headset assembly's cord. More preferably, the plug, cord, jack and headset are all permanently attached to each other.

In addition to such a composite headset assembly, the present invention also is directed to a composite plug/jack assembly, e.g., as described above and/or as shown in FIG. 1, particularly where such an assembly ultimately is connected to a headset. Still further, the present invention also is directed to a jack assembly integrated into a headset cord, e.g., as described above and/or as shown in FIG. 2.

One example of an entire headset assembly according to the present invention is illustrated in FIG. 3. In this example, the headset 152 includes a right-channel over-the-ear headphone 153, a left-channel over-the-ear headphone 154, connected together by a structure for extending over the user's head, and a boom microphone 155. A plug/jack assembly 160 includes both a plug 162 and a jack 165, (e.g., integrated in the manner shown in FIG. 1) for receiving the electrical audio signal output by jack 166 of an audio device, such as computer 167. Jack 165 accepts a plug 168 from another headset assembly, with plug 168 potentially being part of a plug/jack assembly 169 that is similar or identical to plug/jack assembly 160, although plug 168 could instead be a conventional audio plug.

A separate plug assembly 170 includes both a plug 172 and a jack 175, (again, e.g., integrated in the manner shown in FIG. 1) for plugging into the microphone input jack 176 of audio device 167. Once again, jack 175 accepts a plug 178 from another headset assembly, with plug 178 potentially being part of a plug/jack assembly 179 that is similar or identical to plug/jack assembly 170, although again plug 178 could instead be a conventional microphone plug.

In the foregoing example, a first plug assembly 170 is used for the audio signal from microphone 155, and a separate second plug assembly 160 is used for the audio signal driving headphones 153 and 154. However, in alternate embodiments both such signals are accommodated by a single plug/jack assembly. Also, in the present embodiment each of plugs 162 and 172 is part of a plug-jack assembly according to the present invention; in alternate embodiments, only one such plug is part of such a plug/jack assembly and the other is a conventional plug.

In the embodiments in which an audio signal (e.g., stereo or monaural) is being provided from an audio device and shared among various headset assemblies, the main consideration typically is whether the audio device provides enough power to adequately drive all of the connected headsets. Where microphone signals from multiple headset assemblies are being combined, in addition to such drive-power considerations, there sometimes is the additional concern of directly providing a microphone signal to another microphone; accordingly, it sometimes is desirable in such embodiments to use an analog buffer circuit or adder for combining such different microphone signals.

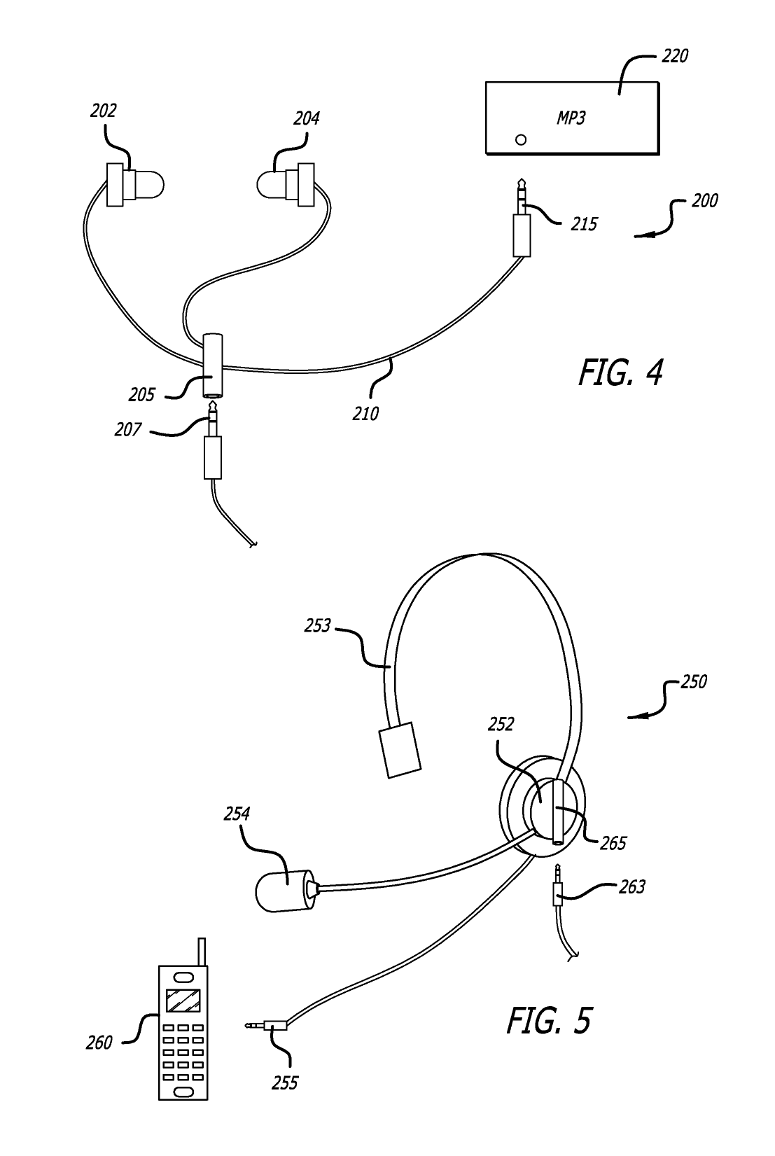

A second example of an entire headset assembly 200 is illustrated in FIG. 4. Here, the headset is implemented as a pair of in-ear stereo headphones 202 and 204, and a jack 205 for accepting the plug 207 from a different headset assembly is integrated into the cord 210 for headset assembly 200 at the point at which cord 210 divides into separate branches for the left and right audio signals (e.g., in the manner discussed above in connection with FIG. 2). Accordingly, in this example, the plug 215 can be configured identically to conventional stereo audio plugs. In any event, the present plug 215 is configured for insertion into an audio device such as MP3 player 220.

A third example of an entire headset assembly 250 is illustrated in FIG. 5. In this example, headset assembly 250 includes a monaural on-the-ear headphone 252 and a boom microphone 254, all within a structure 253 for fitting over the user's head. Thus, in these respects headset assembly 250 is similar to conventional cordless telephone headsets, and even includes a plug 255 for plugging into an audio device, such as cordless telephone 260. However, unlike conventional headset assemblies, the headset portion of headset assembly 250 (in this case, headphone 252) includes a jack 265 for receiving a plug 263 from another headset assembly, so that at least a portion of the audio signal provided to and/or generated by headset assembly 250 (e.g., only the audio signal provided by cordless telephone 260) can be shared with a different headset assembly.

### Additional Considerations.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

What is claimed is:

1. An audio headset assembly, comprising:
a plug configured to mate with an audio device jack;
an audio headset;
a cord that electrically couples the plug to the audio headset; and
a jack that (1) is integrated with at least one of the audio headset, the cord or the plug, (2) is configured to mate with a second plug, and (3) has electrodes electrically coupled to corresponding electrodes of the plug.

2. An audio headset assembly according to claim 1, wherein the second plug is identical to the plug.

3. An audio headset assembly according to claim 1, wherein the jack is integrated with the plug.

4. An audio headset assembly according to claim 3, wherein the jack is coaxially aligned with the plug.

5. An audio headset assembly according to claim 1, wherein the cord includes a dividing point at which left and right audio signals are separated into different branches, and wherein the jack is integrated with the cord at the dividing point.

6. An audio headset assembly according to claim 1, wherein the plug, the cord, the jack and the audio headset are all permanently attached to each other.

7. An audio headset assembly according to claim 1, wherein the audio headset is a stereo headset.

8. An audio headset assembly according to claim 1, wherein the audio headset comprises a microphone.

9. An audio headset assembly according to claim 1, wherein the audio headset is a telephone headset.

10. An audio headset assembly, comprising:
a plug configured to mate with an audio device jack and, upon said mating, to receive an electrical audio signal from the audio device;
a headset, including a transducer that converts the electrical signal into output audio;
a cord extending from the plug to the headset, for conveying the electrical signal from the plug to the headset; and
a headset assembly jack, integrated with at least one of the headset, the cord or the plug, and configured to accept a second plug and thereby supply at least a portion of the electrical signal to the second plug.

11. An audio headset assembly according to claim 10, wherein the second plug is identical to the plug.

12. An audio headset assembly according to claim 10, wherein the headset assembly jack is integrated with the plug.

13. An audio headset assembly according to claim 12, wherein the headset assembly jack is coaxially aligned with the plug.

14. An audio headset assembly according to claim 10, wherein the cord includes a dividing point at which left and right audio signals are separated into different branches, and wherein the headset assembly jack is integrated with the cord at the dividing point.

15. An audio headset assembly according to claim 10, wherein the plug, the cord, the headset assembly jack and the headset are all permanently attached to each other.

16. An audio headset assembly according to claim 10, wherein the headset is a stereo headset.

17. An audio headset assembly according to claim 10, wherein the headset comprises a microphone.

18. An audio headset assembly according to claim 10, wherein the headset is a telephone headset.
